(19) United States
(12) Patent Application Publication
(10) Pub. No.: US 2008/0049439 A1
(43) Pub. Date: Feb. 28, 2008

(54) Light bar assembly

(76) Inventor: Hsu-Cheng Wang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/509,774

(22) Filed: Aug. 25, 2006

(51) Int. Cl. B60Q 1/26

(52) U.S. Cl. 362/542; 362/35; 362/545

(57) ABSTRACT

A light bar assembly for car is disclosed to include an elongated housing, which has a double-beveled design showing a V-shaped profile, circuit boards that are mounted inside the housing each carrying a plurality of LEDs and having recessed reflecting surface portions for reflecting the light the associating LEDs toward the outside of the housing, a control circuit board mounted inside the housing for controlling flashing of the LEDs and a lens covering the housing and fitting the V-shaped profile of the housing.

### BACKGROUND OF THE INVENTION

1. Field of the Invention

The present invention relates to lights and more particularly, to a light bar assembly, which has a double-beveled design showing a V-shaped profile for giving a visual signal in all directions and angles.

2. Description of the Related Art

Regular light bar assemblies for motor vehicles commonly have a rectilinear outer appearance for mounting on a motor vehicle in a transverse direction. Because of the limitation of the rectilinear outer appearance, these conventional light bar assemblies have a visual signal dead angle. Further, when viewing either of the two distal ends of a conventional rectilinear light bar assembly, the indication of the light bar assembly cannot be seen.

### SUMMARY OF THE INVENTION

The present invention has been accomplished under the circumstances in view. It is one object of the present invention to provide a light bar assembly, which gives a visual signal in all directions and angles. It is another object of the present invention to provide a light bar assembly, which has low power consumption and high durability characteristics and is controllable to provide different flashing modes. According to one embodiment of the present invention, the light bar assembly comprises an elongated housing, which has a double-beveled design showing a V-shaped profile, circuit boards that are mounted inside the housing each carrying a plurality of LEDs and having recessed reflecting surface portions for reflecting the light the associating LEDs toward the outside of the housing, a control circuit board mounted inside the housing for controlling flashing of the LEDs and a lens covering the housing and fitting the V-shaped profile of the housing. Further, the lens has two wings at the two distal ends for guiding wind and guiding out the light from the LEDs.

According to an alternate form of the present invention, the light bar assembly comprises an elongated housing, which has a double-beveled design showing a V-shaped profile, at least one plate member fixedly mounted inside the housing, a plurality of rotary tables respectively supported on the at least one plate member inside the housing and rotatable by a motor through 360° relative to the at least one plate member, each rotary table carrying a light emitting diode and a reflector adapted to reflect the light of the light emitting diode, and a lens covering the housing and fitting the V-shaped profile of the housing.

### BRIEF DESCRIPTION OF THE DRAWINGS

FIG. 1 is an exploded view of a light bar assembly according to a first embodiment of the present invention.

FIG. 2A is a sectional view of the light bar assembly according to the first embodiment of the present invention.

FIG. 2B is similar to FIG. 2A but showing the two circuit boards at the two distal ends respectively curved inwards.

FIG. 2C is similar to FIG. 2A but showing the two circuit boards at the two distal ends respectively corrugated.

FIG. 2D is similar to FIG. 2C but showing the two circuit boards at the two distal ends respective curved inwards.

FIG. 3 is an elevational assembly view of the light bar assembly according to the first embodiment of the present invention.

FIG. 4 illustrates the light bar assembly of the first embodiment of the present invention installed in the roof of a car.

FIG. 5 is a schematic drawing showing the effective range of the light bar assembly of the first embodiment of the present invention when installed in the roof of a car.

FIG. 6 is an exploded view of a light bar assembly according to a second embodiment of the present invention.

FIG. 7A˜7C show three different shapes of the light bar assembly according to the second embodiment of the present invention.

FIG. 8 illustrates the light bar assembly of the second embodiment of the present invention mounted on the top side of the trunk cover of a car.

FIG. 9 is an elevational assembly view of a smoothly arched shape of the light bar assembly according to the second embodiment of the present invention.

### DETAILED DESCRIPTION OF THE PREFERRED EMBODIMENT

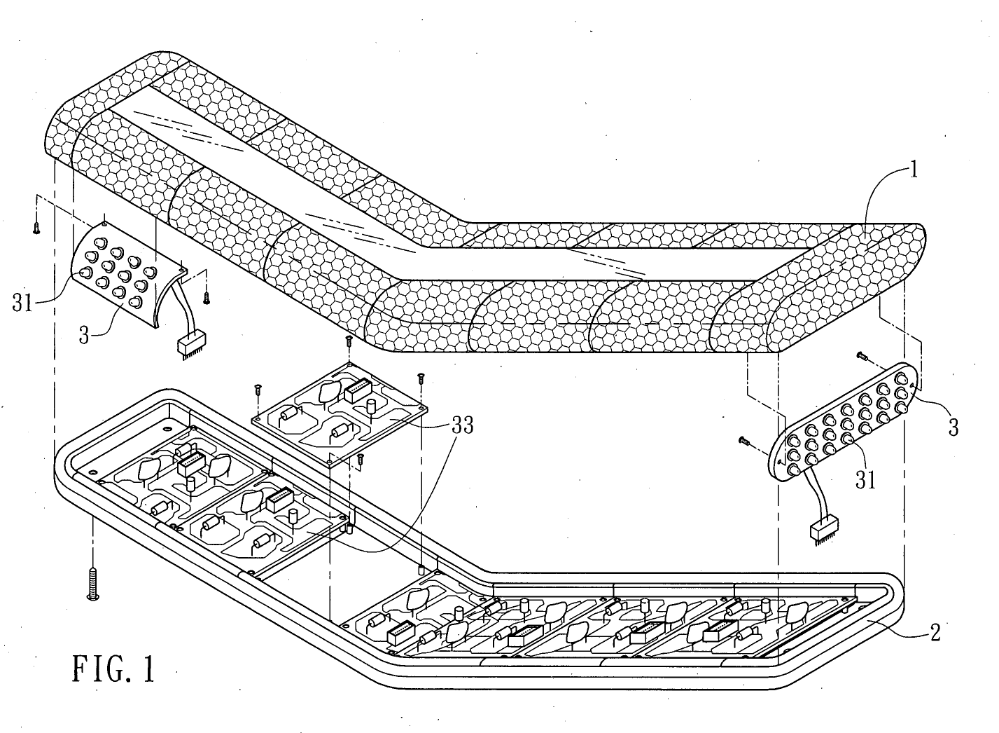

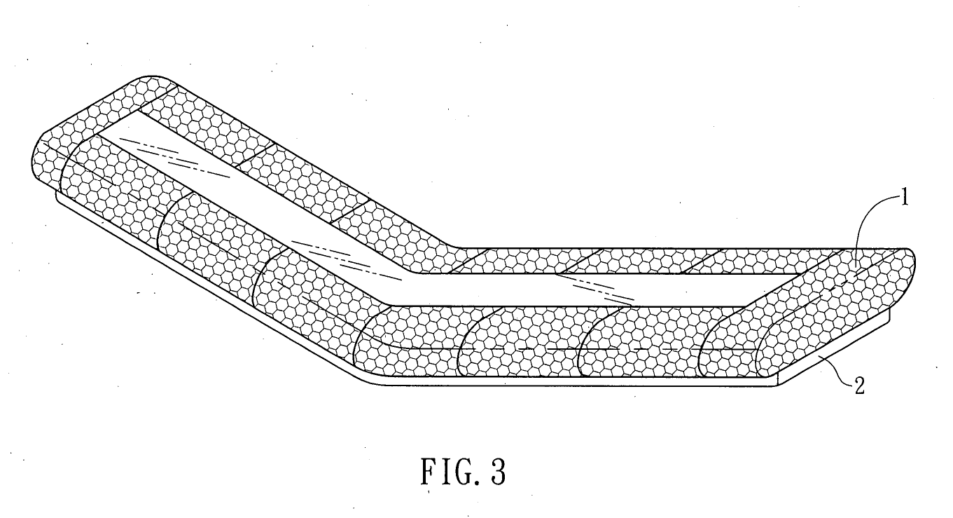

FIGS. 1, 2A, 3 and 4, a light bar assembly in accordance with a first embodiment of the present invention is shown comprised of a lens 1, and a housing 2. The housing 2 has a double-beveled design showing a V-shaped profile. The lens 1 is covered on the top open side of the housing 2, fitting the V-shaped profile Further, a plurality of circuit boards 3 and 34 are arranged inside the housing 2, each having a plurality of recessed reflecting surface portions 311 and a plurality of LEDs (light emitting diodes) 31 respectively mounted in the recessed reflecting surface portions 311. The circuit boards 3 include a number of circuit boards 3 or one single circuit board 34 horizontally arranged inside the housing 2 and the other two circuit boards 3 vertically arranged at the two distal ends inside the housing 2. The housing 2 has mounting screw holes 21 fastened to a bracket 22 with screws.

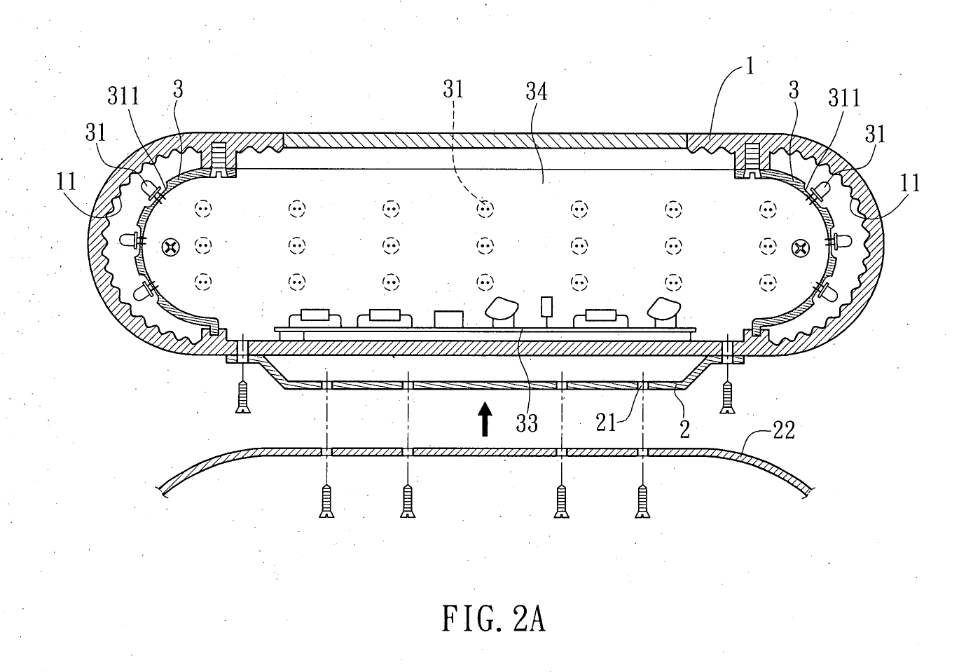

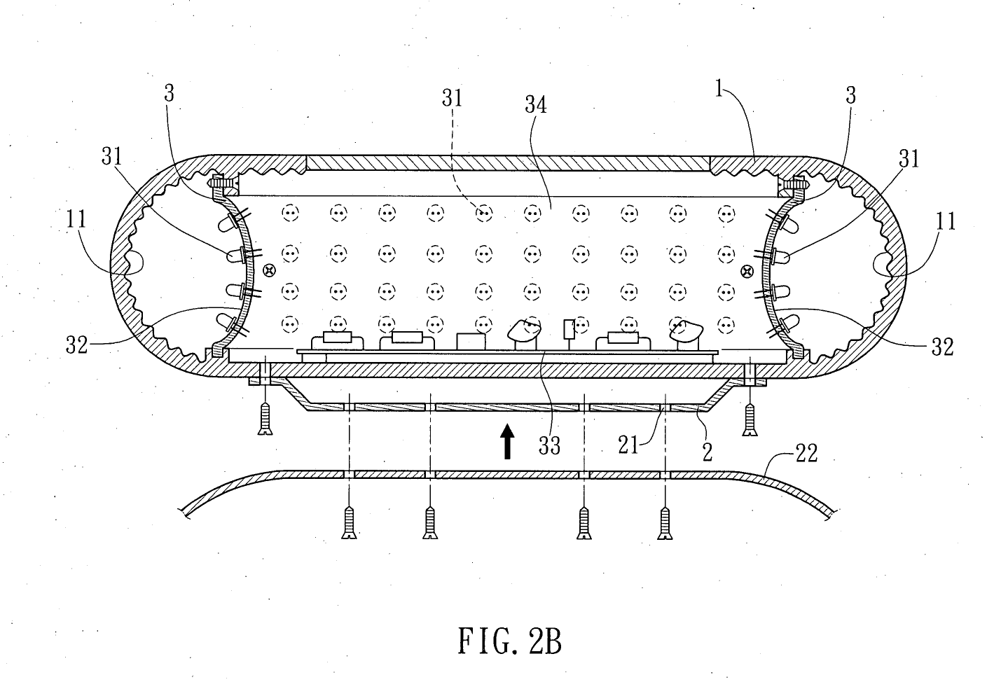

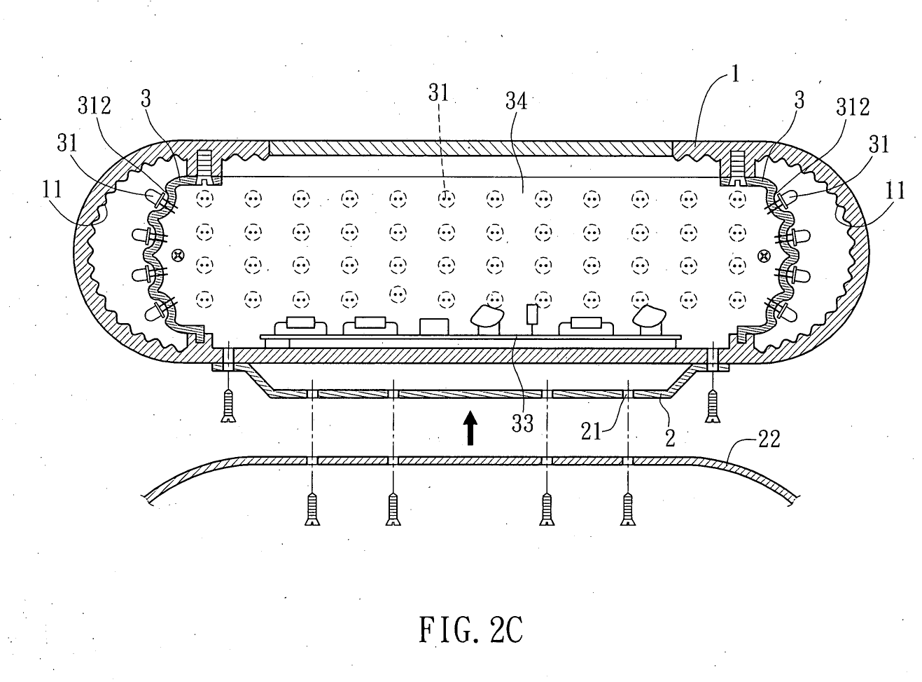

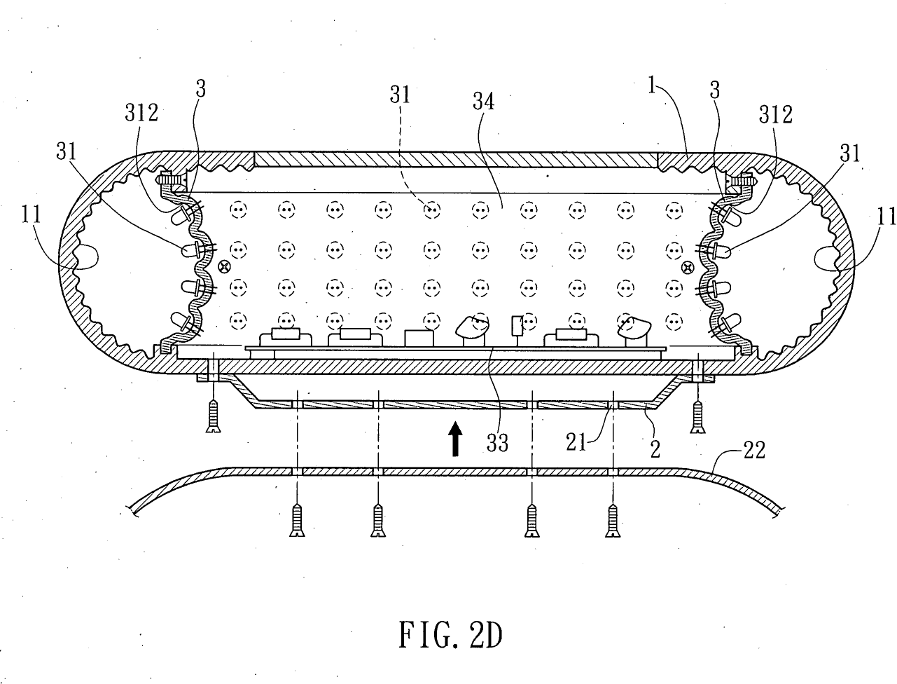

In an alternate form as shown in FIG. 2B, the circuit board 3 is smoothly arched, providing an inwardly curved reflecting surface 32 for reflecting the light of the associating LEDs 31.

In another alternate form as shown in FIGS. 2C and 2D, the circuit board 3 can be corrugated and smoothed curved outwards (see FIG. 2C) or inwards (see FIG. 2D), providing a plurality of reflecting grooves 312 for reflecting the light of the associating LEDs 31.

Further, a control circuit board 33 is mounted inside the housing 2 for controlling the operation mode (flashing) of the LEDs 31. Further, the lens 1 has condensing surface portions 11 for condensing the light of the LEDs 31.

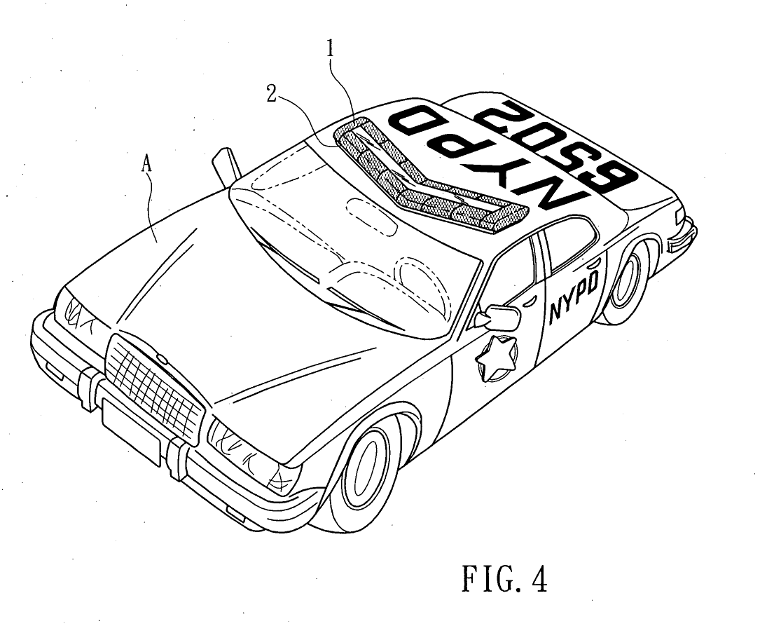

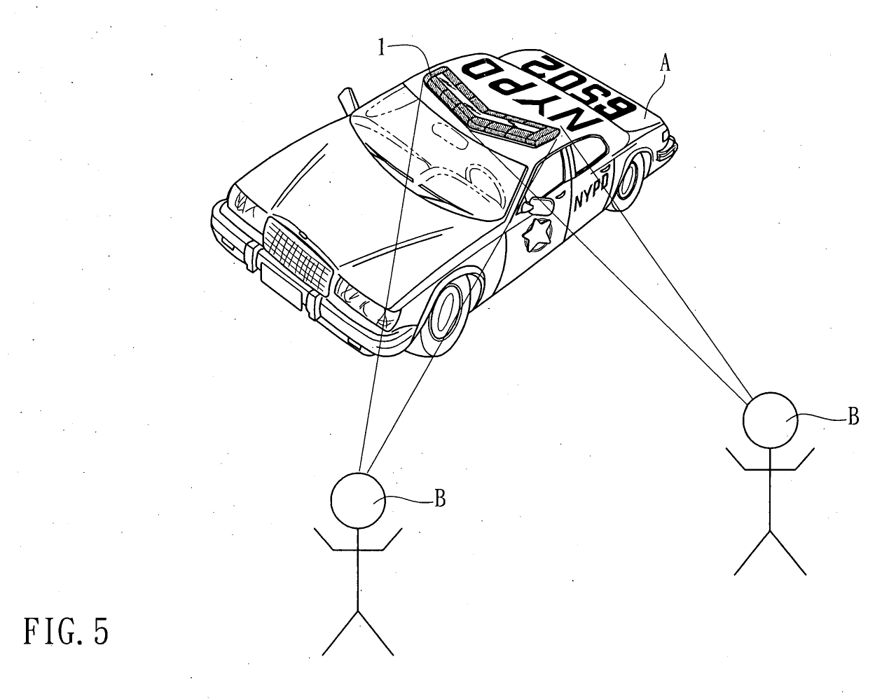

Referring to FIGS. 4 and 5, when in use, the light bar assembly is installed in the roof of a car A to give a visual signal to surrounding cars and people B in all angles.

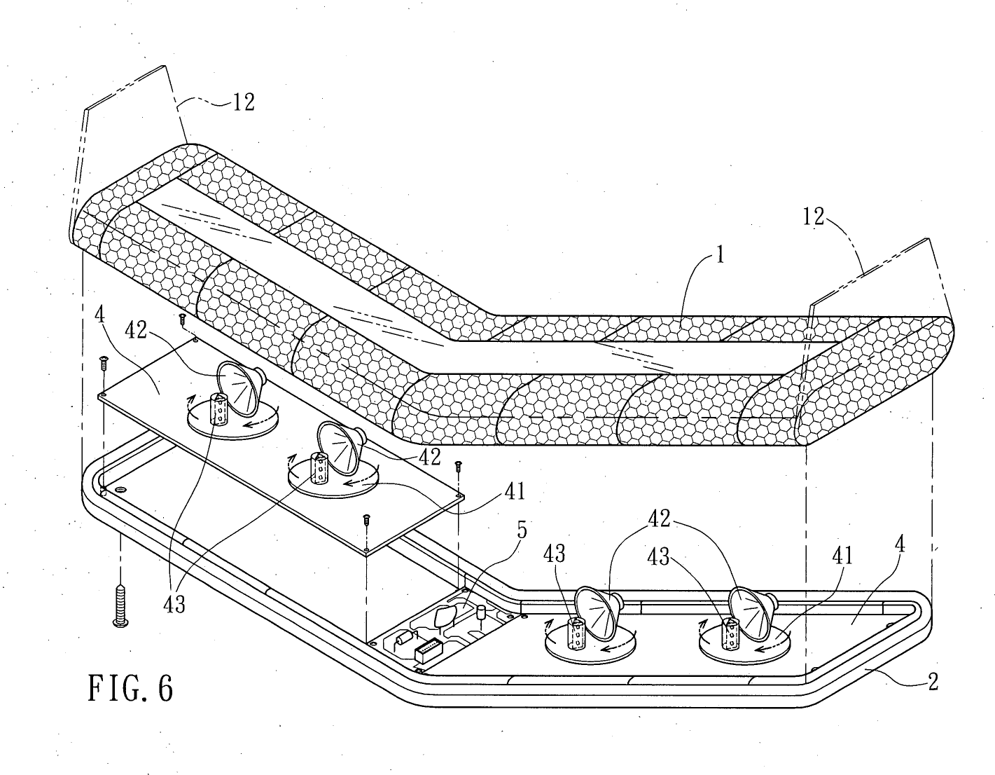

FIG. 6 shows a light bar assembly in accordance with a second embodiment of the present invention. According to this embodiment, the light bar assembly is comprised of a housing 2, a plurality of plate members 4 mounted inside the housing 2, and a lens 1 covering the housing 2. Each plate members 4 carry a plurality of rotary tables 41 rotatable by a motor (not shown). Each rotary table 41 carries a LED 43 and a reflector 42 for reflecting the light of the LED 43. Further, a control circuit board 5 is mounted inside the housing 2 for controlling the rotation of the rotary tables 41 and the operation mode (flashing) of the LEDs 43. Further, the lens 1 has two wings 12 at the two ends for guiding wind. Same as the lens 1, the wings 12 are made of a light guide material for guiding out the light from the LEDs 43.

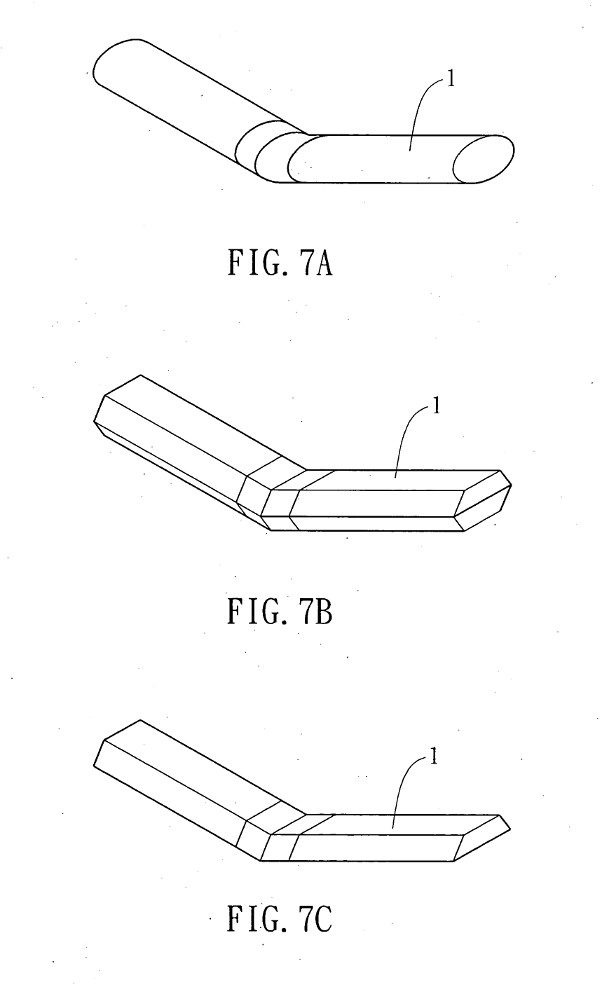

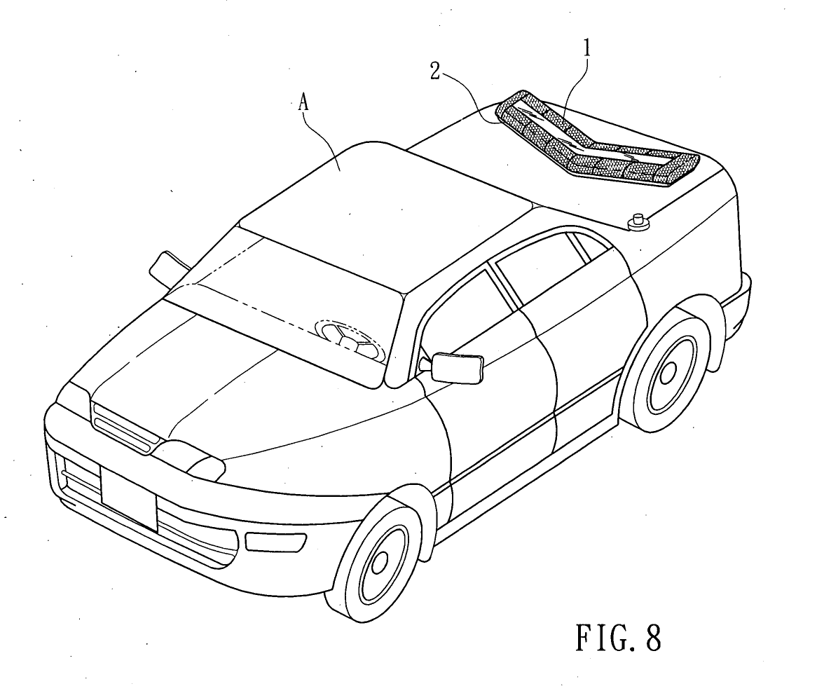

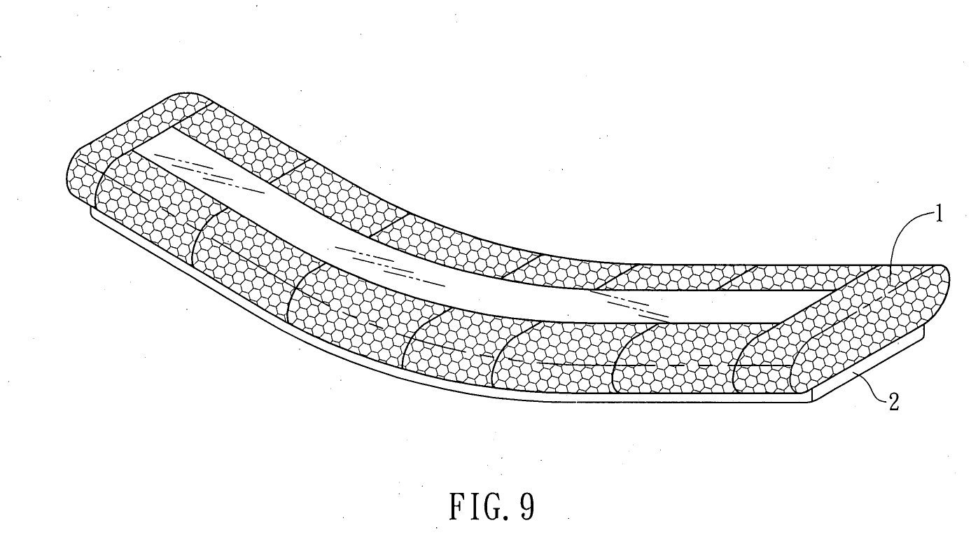

Further, the light bar assembly can be made having any of a variety of outer shapes. FIGS. 7A, 7B, 7C and 9 show four different shapes of the light bar assembly. Further, this second embodiment can be mounted on the top side of the trunk cover of a car for use as a third stop light (see FIG. 8).

A prototype of light bar assembly has been constructed with the features of FIGS. 1˜9. The light bar assembly functions smoothly to provide all of the features discussed earlier.

Although particular embodiments of the inventions have been described in detail for purposes of illustration, various modifications and enhancements may be made without departing from the spirit and scope of the invention. Accordingly, the invention is not to be limited except as by the appended claims.

What the invention claimed is:

1. A light bar assembly comprising:
an elongated housing, said housing having a double-beveled design showing a V-shaped profile;
at least one circuit board respectively mounted inside said housing, said at least one circuit board each having a plurality of recessed reflecting surface portions and a plurality of light emitting diodes respectively mounted in said recessed reflecting surface portions in such a manner that the recessed reflecting surface portions reflect the light the associating light emitting diodes toward the outside of said elongated housing;
a control circuit board mounted inside said housing and adapted to control flashing of said light emitting diodes; and
a lens covering said housing, said lens having a double-beveled design showing a V-shaped profile fitting the V-shaped profile of said housing.

2. The light bar assembly as claimed in claim 1, wherein said lens and said housing have a smoothly arched cross section.

3. The light bar assembly as claimed in claim 1, wherein said lens has two wings made of a light guide material and arranged at two distal ends thereof for guiding wind and guiding out light from said light emitting diodes.

4. A light bar assembly comprising:
an elongated housing, said housing having a double-beveled design showing a V-shaped profile;
at least one plate member fixedly mounted inside said housing;
a plurality of rotary tables respectively supported on said at least one plate member inside said housing and rotatable by a motor through 360° relative to said at least one plate member, said rotary tables each carrying a light emitting diode and a reflector adapted to reflect the light of said light emitting diode; and
a lens covering said housing, said lens having a double-beveled design showing a V-shaped profile fitting the V-shaped profile of said housing.

5. The light bar assembly as claimed in claim 4, wherein said lens has two wings made of a light guide material and arranged at two distal ends thereof for guiding wind and guiding out light from said light emitting diodes.

6. The light bar assembly as claimed in claim 4, further comprising a control circuit board mounted inside said housing and adapted to control rotation of said rotary tables and flashing of said light emitting diodes.

7. The light bar assembly as claimed in claim 4, wherein said lens and said housing have a smoothly arched cross section.
